(19) United States
(12) Patent Application Publication
(10) Pub. No.: US 2016/0347493 A1
(43) Pub. Date: Dec. 1, 2016

(54) BOTTLING AND LABELING MACHINE

(71) Applicant: Elum Inc., Modesto, CA (US)

(72) Inventor: Svatoboj Otruba, Ceres, CA (US)

(21) Appl. No.: 14/724,223

(22) Filed: May 28, 2015

(51) Int. Cl. B65C 3/16; B65C 9/04; B65C 9/08

(52) U.S. Cl. CPC B65C 3/16; B65C 9/08; B65C 9/04

(57) ABSTRACT

A servo controlled labeling apparatus, comprises a conveyor for supplying a plurality of articles through a conveyor guide, an active star wheel having a plurality of arms to form a plurality of pockets, a rotating roller star drum having a plurality of rollers and a vacuum drum rotatable about a drum axis positioned opposite the rotating roller star drum. A servomechanism controls the infeed acceleration of the active star wheel and the speed of each of the plurality of articles. Each of the plurality of articles fed through the conveyor goes past the active star wheel, then between at least two of the plurality of rollers of the rotating roller star drum and the vacuum drum, which spins each of the plurality of articles into the labeling zone by the speeding up of the rotating roller star drum and the slowing down of the vacuum drum for the application of the label thereto.

### BACKGROUND OF THE DISCLOSURE

Technical Field of the Disclosure

The present embodiment relates in general to bottling and labeling machines. More specifically, the present embodiment relates to a bottling and labeling machine that can control the in feed accelerations of containers by means of a servo mechanism.

Description of the Related Art

Labeling machines are used to apply labels to all types of containers both cylindrical, non-cylindrical and regular and irregular shaped polygons. The introduction of adhesive-backed pressure sensitive labels and hand-held, manually operated applicators has greatly facilitated the marking of objects. However, the use of a hand-held label applicator in a high speed operation would be unacceptably slow, inefficient, labor intensive and therefore, impractical due to the time constraints associated with high volume production. As a result, automated, high speed labeling machines have been developed to apply labels to containers passing through a labeling station on, for example, a conveyor belt. In certain labeling machines, the containers to be labeled are positioned on a conveyor and moved in a controlled manner into a labeling zone.

In conventional labeling machines, a continuous label material is removed from a roll and fed to a cutting system. The continuous label material is then cut into labels that are transferred face down onto the circumferential surface of a vacuum drum where they are held in place by vacuum. As the drum rotates the labels pass a glue applicator that applies adhesive to the back (inner) surface of the label. The label, with the adhesive applied thereto, is released from the drum as it comes into contact with and is applied to a container. The pressure-sensitive labels are commonly precut and carded on a continuous web of material often called backing material which is on a roll for mounting on the labeling machine. Labeling machines that can be adjusted to process labels and containers of different sizes are available. These machines, however, frequently require a skilled technician to spend from four to six hours to effect the adjustments that are needed to apply labels to container sizes that are different from the label and container sizes in the preceding production run. To make these machine component adjustments, it is usually necessary to start the labeling apparatus after an initial adjustment, stop the machinery and make additional adjustments, then start the labeling machinery again and keep repeating this adjustment cycle until suitable adjustments for the machine components are achieved.

One existing labeling machine comprises a conveyor of containers, each to be labeled by cutting from a continuous ribbon wound in a reel, and further comprising feeder elements which are adapted to convey with the appropriate timing the ribbon to a device for the intermittent cutting of each individual label, and elements for locking the label during cutting which are inserted between the cutting device and a drum for transferring the cut label to a container provided on the conveyor. However, the containers can often fall over when the machinery is stopped, because they are not always exactly the same shape and can lead to potential instability.

Another existing labeling machine comprising a cylindrical vacuum drum, a feed screw located in relation to the vacuum drum to move cylindrical containers from a starting point to a release point past the vacuum drum with their cylinder axes parallel to the cylinder axis of the vacuum drum, and in tangent contact with the vacuum drum. It also includes a continuous drive belt located to contact the sides of containers opposite the sides in contact with the feed screw, said belt serving to spin the containers from the starting point to the release point. However, this labeling machine uses feed screws, which make the setup complicated. With bottles of a more complex shape, the machine needs double feed screws, which are an even more complicated set up. At some point the continuous belt may not move at the exact same speed and the machine needs double screws to prevent the containers from falling.

Another existing high-speed container labeling machine comprises a conveyor, a pressure sensitive label applying apparatus, a star wheel and at least one indexing mechanism. The conveyor moves the containers to and from the star wheel. The indexing mechanism aligns the star wheel to present the container into a perpendicular relation with the label applying apparatus and holds the container until the label adheres to the container. The indexing mechanism releases the star wheel, which directs the container carrying the label to the conveyor. However, this high-speed container-labeling machine does not have the means to control the speed of the containers coming into the labeling zone.

Therefore there is a need for a labeling machine that will provide a continuous movement of containers along a conveyor belt. Such a machine would not need to stop the conveyor at all to make adjustments, which would prevent the containers from falling. Such a needed machine would be employed for labeling containers of different shapes, and would provide the capability to allow control of the speed of the containers coming into the labeling zone. Such a needed machine would be simple in construction, does not require mechanical components and eliminates the space between the containers so they hold each other upright. The present invention overcomes the prior art shortcomings by accomplishing these objectives.

### SUMMARY OF THE DISCLOSURE

To minimize the limitations found in the prior art, and to minimize other limitations that will be apparent upon the reading of the specifications, the preferred embodiment of the present invention provides a labeling apparatus that controls the in feed accelerations of a plurality of articles by means of a servo mechanism.

The labeling apparatus comprises a conveyor for supplying the plurality of articles into a labeling zone controlled by a servo mechanism, an active star wheel, a rotating roller star drum and a vacuum drum rotatable about a drum axis and positioned opposite the rotating roller star drum. The plurality of articles is fed to the conveyor having a conveyor guide to constrain the plurality of articles thereto. The servomechanism includes a servomotor that is controlled by a programmed control panel with a user machine interface to control the rotation of the active star wheel and thus the rotating roller star drum to move the plurality of articles toward and away from the labeling zone through the conveyor. The active star wheel adaptable to rotate about a central axis by means of the servomechanism includes a plurality of arms to form a plurality of pockets. The rotating roller star drum includes a plurality of rollers. The plurality of rollers is, preferably, made of flexible polymers. Each of the plurality of rollers includes a plurality of flexible discs arranged in a stacked manner. Each of the plurality of articles propagating from the active star wheel is guided to at least two of the plurality of rollers of the rotating roller star drum. The rotating roller star drum moves the plurality of articles further towards the vacuum drum. The vacuum drum is positioned opposite to the rotating roller star drum and adaptable to rotate about a drum axis. The vacuum drum holds the label to be applied to the plurality of articles. When each of the plurality of articles is pressed against the plurality of rollers of the rotating roller star drum and the vacuum drum, the plurality of rollers deforms slightly due to the pressure and the label is applied on to each of the plurality of articles.

A first objective of the present invention is to provide a servo controlled labeling apparatus that provides a continual motion of the plurality of articles through the conveyor.

A second objective of the present invention is to provide a servo controlled labeling apparatus that has a servo controlled active star wheel to control the infeed acceleration of the plurality of articles.

A third objective of the present invention is to provide a servo controlled labeling apparatus with the vacuum drum speeding up and the rotating roller star drum slowing down to provide rotational motion to the plurality of articles as it enters the labeling zone.

A fourth objective of the present invention is to provide a servo controlled labeling apparatus that is simple in construction, does not require mechanical components and eliminates the space between the containers so that they hold each other upright.

Another objective of the present invention is to provide a servo controlled labeling apparatus having a conveyor speed dependent on the diameter of the plurality of articles conveyed through the conveyor by means of the servomechanism.

Yet another objective of the invention is to provide a servo controlled labeling apparatus that can be employed for all types of articles, both cylindrical, non-cylindrical and regular and irregular shaped polygons.

Still another objective of the invention is to provide a servo controlled labeling apparatus that prevents falling of the plurality of articles coming at the take-out end of the conveyor.

These and other advantages and features of the present invention are described with specificity so as to make the present invention understandable to one of ordinary skill in the art.

### BRIEF DESCRIPTION OF THE DRAWINGS

In order to enhance their clarity and improve understanding of these various elements and embodiments of the invention, elements in the figures have not necessarily been drawn to scale. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a perspective view of a labeling apparatus according to a preferred embodiment of the present invention;

FIG. 2 illustrates a top plan view of the labeling apparatus according to the preferred embodiment of the present invention;

FIG. 3A illustrates a top view of the labeling apparatus with an article nearing the active star wheel according to the preferred embodiment of the present invention;

FIG. 3B illustrates a top view of the labeling apparatus with the active star wheel receiving the article according to the preferred embodiment of the present invention;

FIG. 3C illustrates a top view of the labeling apparatus with the article between the active star wheel and at least two of the plurality of rollers of the rotating roller star drum according to the preferred embodiment of the present invention;

FIG. 3D illustrates a top view of the labeling apparatus with the article between the rotating roller star drum and the vacuum drum according to the preferred embodiment of the present invention;

FIG. 3E illustrates a top view of the labeling apparatus with the article released from the labeling zone according to the preferred embodiment of the present invention; and

FIG. 4 is a schematic illustration of the control system of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. Finally, many of the steps are presented below in an order intended only as an exemplary embodiment. Unless logically required, no step should be assumed to be required earlier in the process than a later step simply because it is written first in this document.

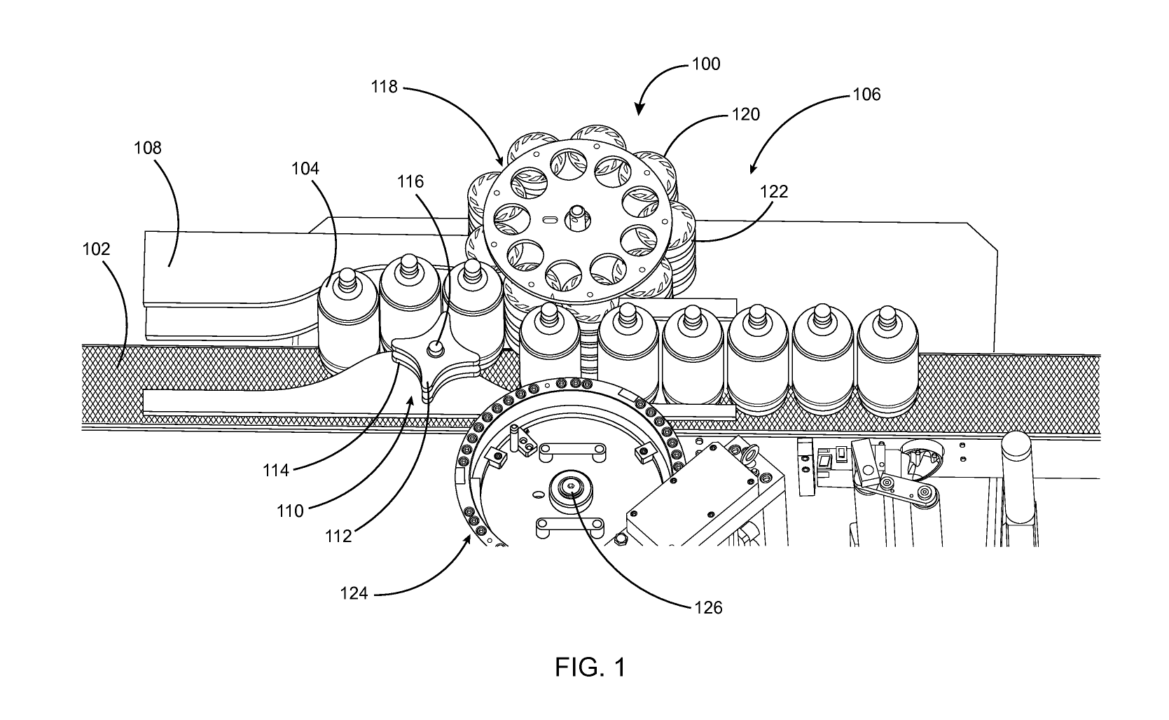

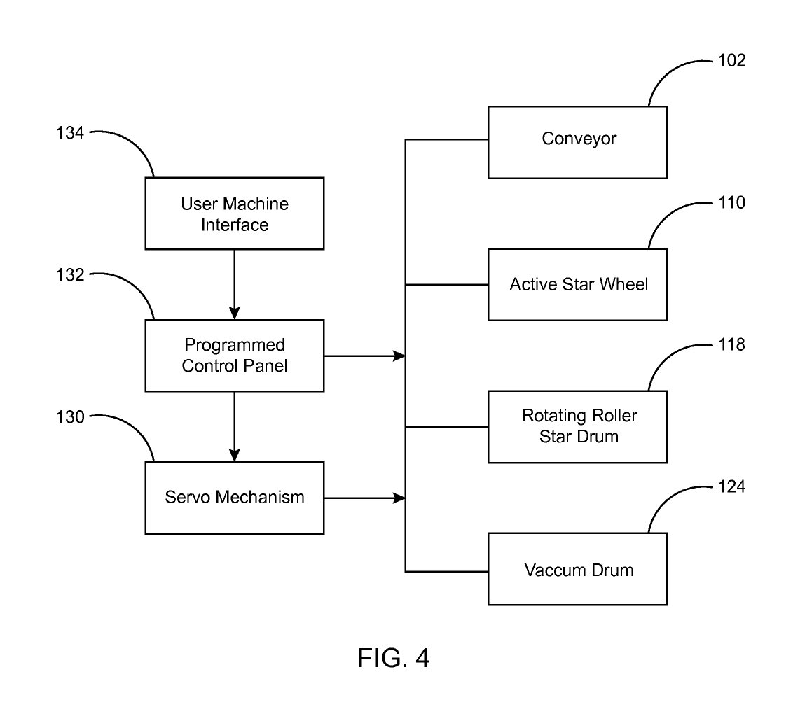

FIG. 1 illustrates a perspective view of a labeling apparatus 100 according to a preferred embodiment of the present invention. The labeling apparatus 100 provides continual motion of the articles coming to the labeling zone and does not stop in one place like those seen in the conventional systems. The labeling apparatus 100 comprises a conveyor 102 for supplying a plurality of articles 104 into a labeling zone 106 controlled by a servo mechanism 130, an active star wheel 110, a rotating roller star drum 118 and a vacuum drum 124 rotatable about a drum axis 126 and positioned opposite the rotating roller star drum 118. The labeling apparatus 100 is used for labeling the plurality of articles 104 coming to the labeling zone 106. The plurality of articles 104 can be bottles, cans or containers of both cylindrical, non-cylindrical shape and regular and irregular shaped polygons. The plurality of articles 104 is fed to the conveyor 102 having a conveyor guide 108 to constrain the plurality of articles 104 thereto. The conveyor 102 is of a known type having a feed-in end and a take-out end. The conveyor 102 is driven by the servomechanism 130 (see FIG. 4) and supplies the plurality of articles 104 from the feed-in end to the active star wheel 110. The servo mechanism 130 (see FIG. 4) includes a servomotor (not shown) that is controlled by a programmed control panel 132 (see FIG. 4) with a user machine interface 134 (see FIG. 4) to control the rotation of the active star wheel 110 and thus the rotating roller star drum 118 to move the plurality of articles 104 toward and away from the labeling zone 106 through the conveyor 102. The active star wheel 110 includes a plurality of arms 112 to form a plurality of pockets 114. The active star wheel 110 is adaptable to rotate about a central axis 116 by means of the servomechanism 130 (see FIG. 4) and each of the plurality of pockets 114 is adaptable to receive each of the plurality of articles 104 supplied through the conveyor 102. The servo mechanism 130 (see FIG. 4) and the active star wheel 110 provide continuous motion of the plurality of articles 104 into the labeling zone 106 and control the infeed acceleration of the plurality of articles 104. The rotating roller star drum 118 includes a plurality of rollers 120. The plurality of rollers 120 is, preferably, made of flexible polymers. Each of the plurality of rollers 120 includes a plurality of flexible discs 122 arranged in a stacked manner. Each of the plurality of articles 104 propagating from the active star wheel 110 is guided to at least two of the plurality of rollers 120 of the rotating roller star drum 118. The rotating roller star drum 118 moves the plurality of articles 104 further towards the vacuum drum 124. The vacuum drum 124 is positioned opposite to the rotating roller star drum 118 and adaptable to rotate about a drum axis 126. Each of the plurality of articles 104 is always under the control of the active star wheel 110, the rotating roller star drum 118 and the vacuum drum 124. Each of the plurality of articles 104 first touches the star wheel 110 and then touches both the star wheel 110 and the rotating roller star drum 118. Then it no longer touches the star wheel 110 but continues contact with the rotating roller star drum 118 and the vacuum drum 124. The vacuum drum 124 holds the label to be applied to the plurality of articles 104. The rotating roller star drum 118 operates at a different speed with respect to speed of the vacuum drum 124. The speed of the vacuum drum 124 increases above the speed of the rotating roller star drum 118, which imparts a rotational motion to the plurality of articles 104. When each of the plurality of articles 104 is pressed against at least two of the plurality of rollers 120 of the rotating roller star drum 118 and the vacuum drum 124, the plurality of rollers 120 deforms slightly due to the pressure and the label is applied on to each of the plurality of articles 104.

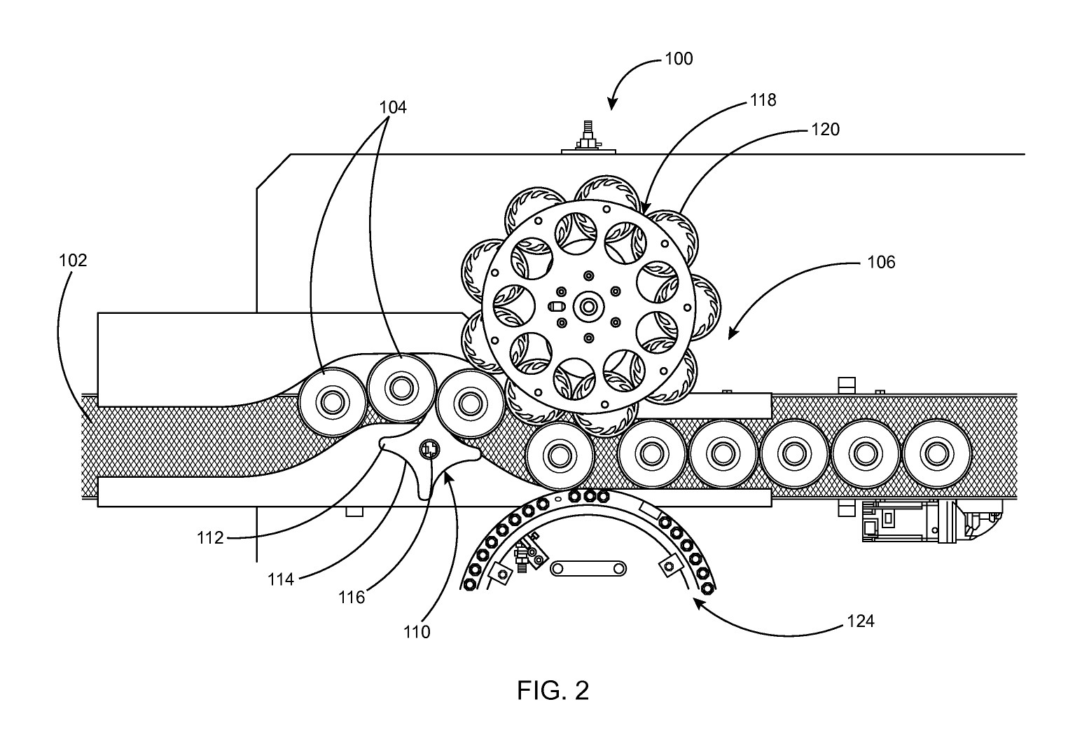

FIG. 2 illustrates a top plan view of the labeling apparatus 100 according to the preferred embodiment of the present invention. In the labeling apparatus 100, the plurality of articles 104 positioned on the conveyor 102 is moved in a continuous manner by the servomechanism 130. The servomechanism 130 preferably controls the rotation of the active star wheel 110, the rotating roller star drum 118 and the vacuum drum 124. The servo controlled active star wheel 110 employed in the present embodiment can feed the plurality of articles 104 of any size into the labeling zone 106. The programmed control panel 132 is pre-programmable and can store many different functions like bottle size, speed or other parameters and each function can be varied and changed as needed to meet the needs of a particular labeling operation. The rate by which each of the plurality of articles 104 is moved through the conveyor 102 is stored in the programmed control panel 132. The speed of the plurality of articles 104 coming in to the labeling zone 106 at the in feed of the conveyer 102 is actually moving very slightly slower than the speed of the conveyer 102, that is, the plurality of articles 104 can be considered as sliding backwards with respect to the conveyer 102. After the labeling zone 106 they are moving at a different speed because the backpressure is zero. The speed of the conveyer 102 is dependent on the diameter of the plurality of articles 104.

As the plurality of articles 104 is fed through the conveyor 102, each of the plurality of articles 104 first touches the active star wheel 110. The rotation of the active star wheel 110 moves each of the plurality of articles 104 forward. Then each of the plurality of articles 104 is caught between at least two of the plurality of rollers 120 of the rotating roller star drum 118 which further moves each of the plurality of articles 104 forward which touches both the star wheel 110 and the rotating roller star drum 118. Then it no longer touches the star wheel 110 but continues contact with the rotating roller star drum 118 and the vacuum drum 124. The rotating roller star drum 118 rotates in counter clockwise direction and the vacuum drum 124 rotates in clockwise direction. The speed of the vacuum drum 124 controlled by the servomechanism 130 increases above the speed of the rotating roller star drum 118, which imparts a rotational motion to each of the plurality of articles 104. As the label enters the labeling zone 106 the speed of the vacuum drum 124 increases, to push each of the plurality of articles 104 forward and as each of the plurality of articles 104 comes out of the labeling zone 106 the speed of the vacuum drum 124 is decreased. By the proper geometry by the conveyor guide 108, the active star wheel 110 and the rotating roller star drum 118 a smooth vector of speed change can be achieved.

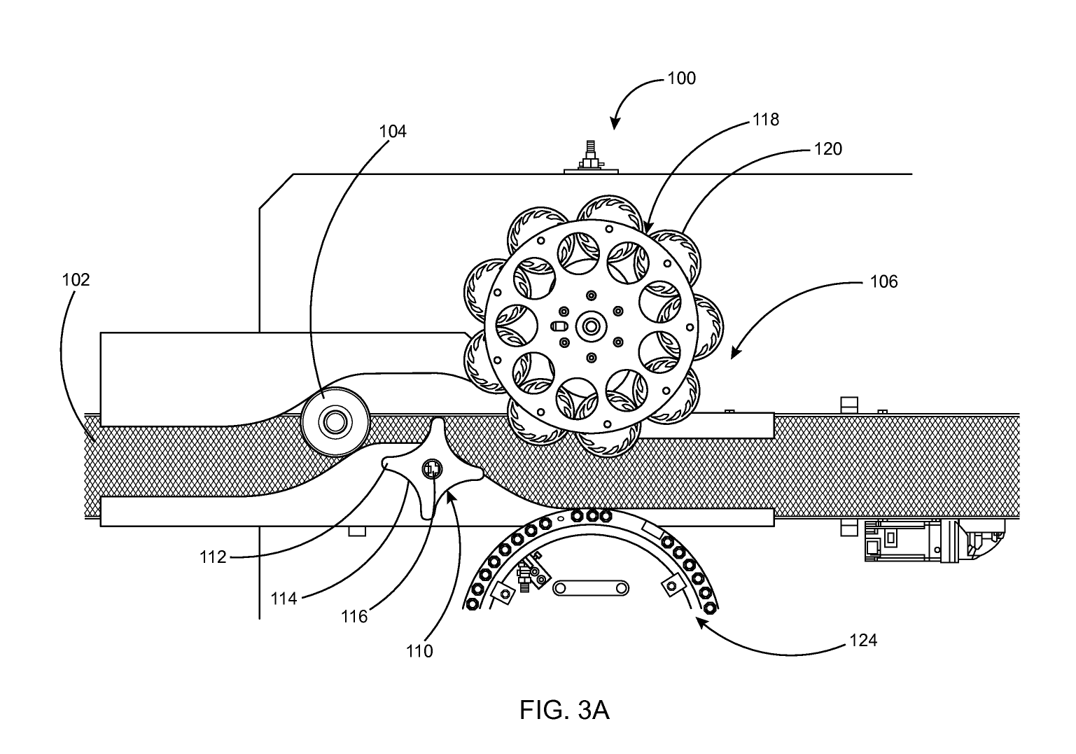

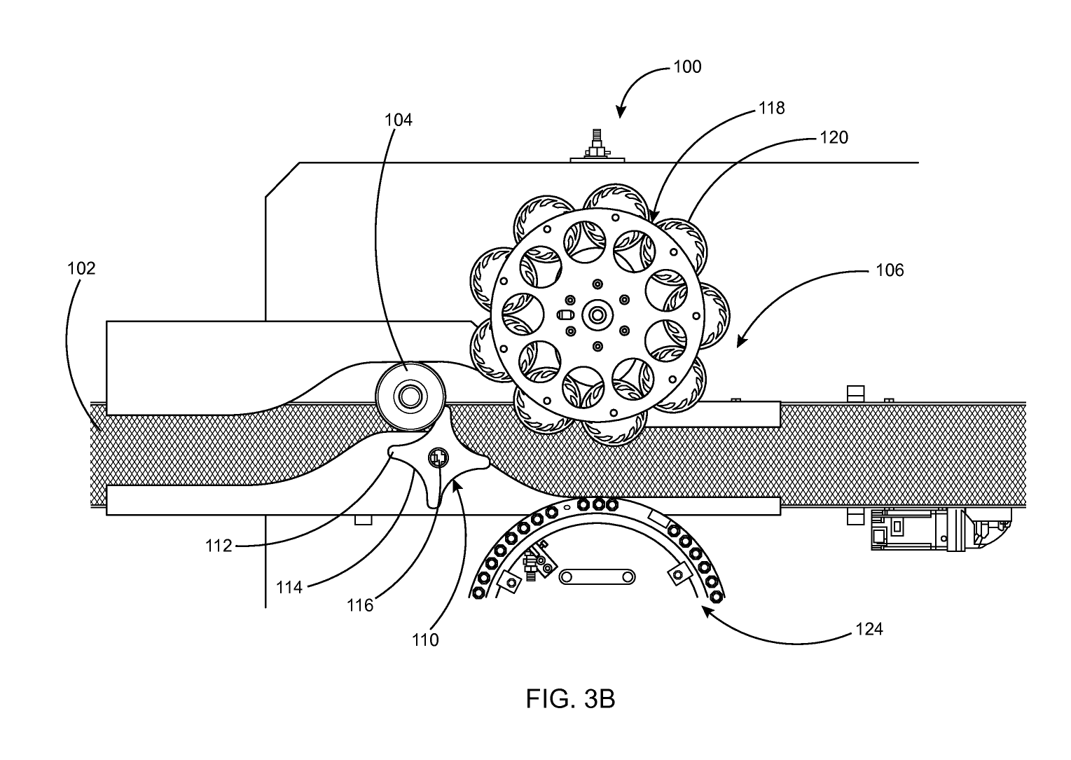

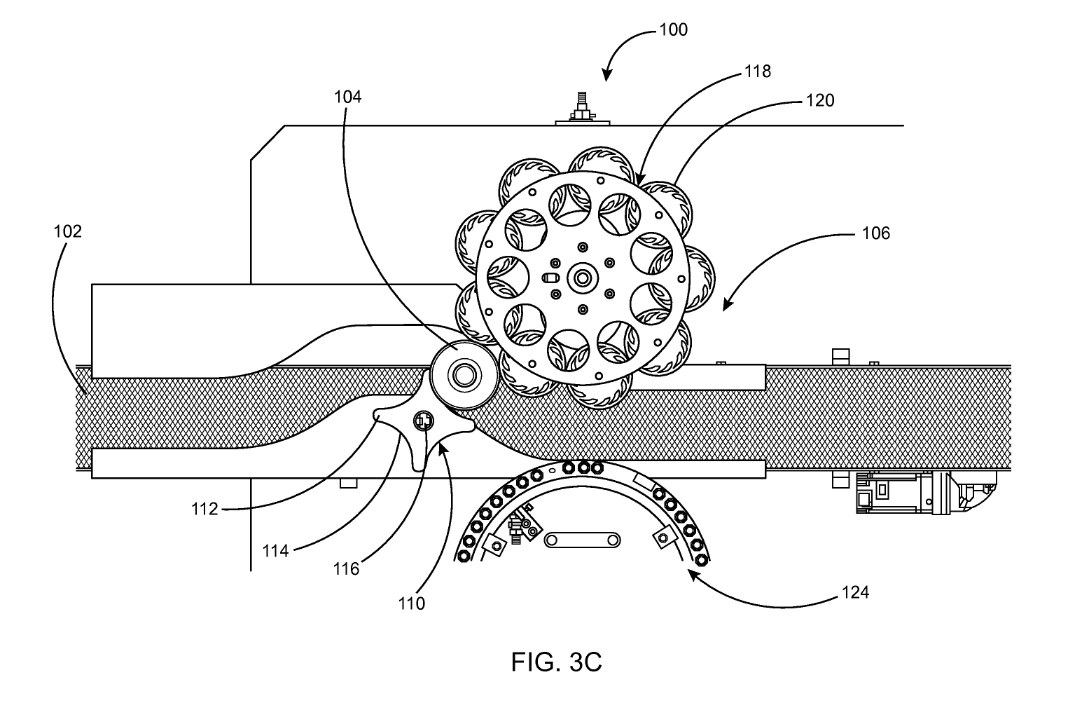

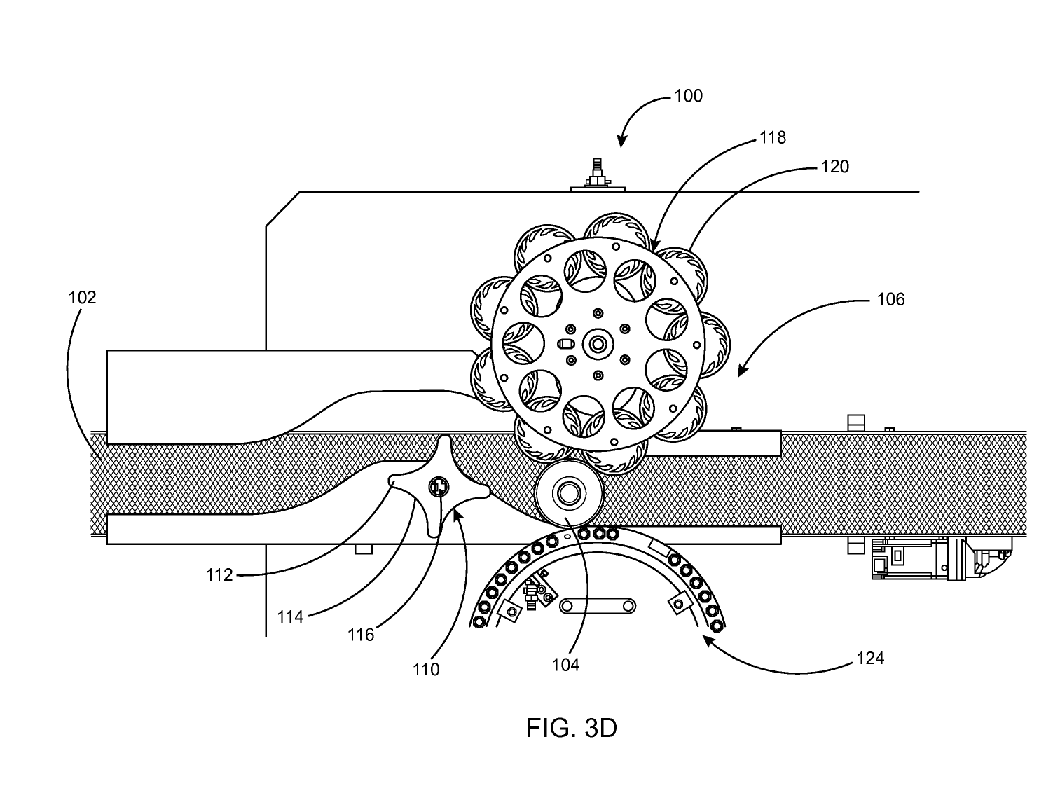

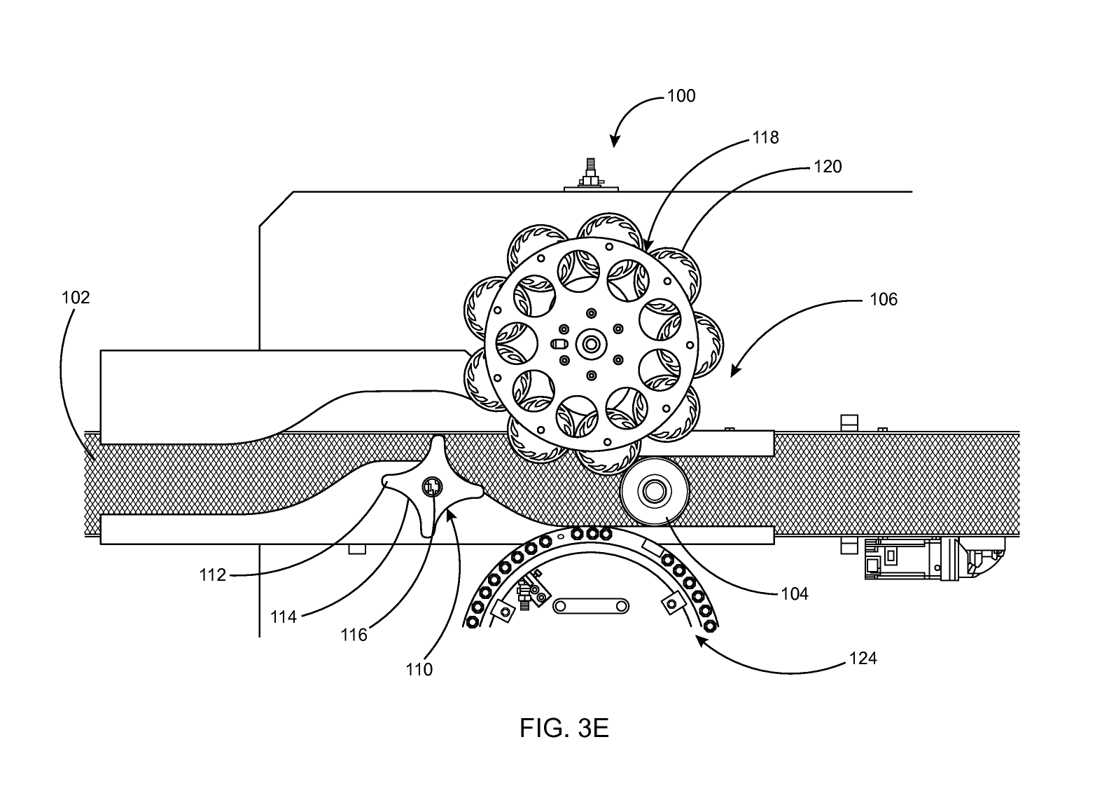

FIGS. 3A-3E illustrates a schematic top view of various steps of operation of the labeling apparatus 100 according to the preferred embodiment of the present invention. The method for applying label to each of the plurality of articles 104 includes moving each of the plurality of articles 104 into the labeling zone 106 through the conveyor 102 by means of the servomechanism 130. Each of the plurality of articles 104 is guided to the active star wheel 110 through the conveyor guide 108 as shown in FIG. 3A. At least one of the plurality of articles 104 is received by at least one of the plurality of pockets 114 of the active star wheel 110 as shown in FIG. 3B. The active star wheel 110 controlled by the servomechanism 130 controls the in feed acceleration of the plurality of articles 104. The active star wheel 110 reduces the acceleration changes and provides a more constant acceleration. The active star wheel 110 rotates in clockwise direction which collects the at least one of the plurality of articles 104 on at least one of the plurality of pockets 114 and guides it towards the rotating roller star drum 118. Then the at least one of the plurality of articles 104 comes in contact with the rotating roller star drum 118 rotating in the counter clockwise direction as shown in FIG. 3C. At least two of the plurality of rollers 120 of the rotating roller star drum 118 forces each of the plurality of articles 104 forward. Now each of the plurality of articles 104 comes between and in contact with at least two of the plurality of rollers 120 of the rotating roller star drum 118 and the vacuum drum 124 as shown in FIG. 3D. Then spinning each of the plurality of articles 104 into the labeling zone 106 by speeding up the rotating roller star drum 118 and slowing down the vacuum drum 124 by the servo mechanism 130 for the application of the label thereto. The vacuum drum 124 rotating in the clockwise direction squishes each of the plurality of articles 104 between the rotating roller star drum 118 and the vacuum drum 124, applying the label positioned on the vacuum drum 120 on each of the plurality of articles 104. Then the at least one of the plurality of articles 104 comes out of the rotating roller star drum 118 and the vacuum drum 124 by speeding up the rotating roller star drum 118 and slowing down the vacuum drum 124 as shown in FIG. 3E. The rotating roller star drum 118 positioned opposite the vacuum drum 120, and which in combination with the vacuum drum 120 spins each of the plurality of articles 104 for application of the label (not shown). The rotating roller star drum 118 operates at a different speed from the vacuum drum 120, and thereby imparts a rotational motion to each of the plurality of articles 104 so that the label is applied. The labeling angle is preferably 20 degrees. This means the plurality of articles 104 has only 20 degrees as viewed from the vacuum drum 124 to have the label applied. Traditional machines have a labeling angle of more like 90 degrees. The present embodiment causes the rotation of the plurality of articles 104 by speeding up the vacuum drum 124 and slowing down the rotating roller star drum 118. This forces the plurality of articles 104 to spin slightly in place. For instance, if the label covers 75 degrees of the vacuum drum 124 and the operator wishes for the whole label applied over 20 degrees, then to get the label applied on each of the plurality of articles 104 the vacuum drum 124 speeds up compared to the rotating roller star drum 118 by a ratio of 75/20.

FIG. 4 is a schematic illustration of the control system of the present invention. The control system of the present invention includes the servomechanism 130 controlled by the programmed control panel 132 having the user machine interface 134 through which the user can enter the required information. The labeling apparatus 100 starts up automatically. The programmed control panel 132 includes a plurality of parameters and programs to control the speed of the conveyor 102, the active star wheel 110, the rotating roller star drum 118 and the vacuum drum 124. The speed of the conveyor 102, the positioning of the plurality of articles 104, the speed and direction of rotation of the active star wheel 110, the rotating roller star drum 118 and the vacuum drum 124 are all variably controlled from the programmed control panel 132. Such parameters may be pre-stored and selected or may be individually entered for any type of articles like cylindrical, non-cylindrical and regular and irregular shaped polygons. The rate at which the units move is programmed into the programmed control panel 132. The use of the programmed control panel 132 allows for programmable selection of the different portions, operation and positioning of the components of the labeling apparatus 100 without any mechanical modification.

The labeling apparatus 100 of the present embodiment does not stop the conveyor 102 to make adjustments, which prevents the plurality of articles 104 from falling. The labeling apparatus 100 is employed for labeling the plurality of articles 104 of different shapes, and is simple in construction and eliminates the space between each of the plurality of articles 104.

I claim:

1. A servo controlled labeling apparatus, comprising:
a conveyor for supplying a plurality of articles into a labeling zone through a conveyor guide, the conveyor guide configured to constrain the plurality of articles passing there through;
an active star wheel having a plurality of arms to form a plurality of pockets, each of the plurality of pockets adaptable to receive each of the plurality of articles through the conveyor, the active star wheel adaptable to rotate about a central axis;
a rotating roller star drum having a plurality of rollers, each of the plurality of rollers includes a plurality of flexible discs arranged in a stacked manner, the rotating roller star drum employed to guide each of the plurality of articles from the active star wheel to the labeling zone utilizing at least two of the plurality of rollers;
a vacuum drum rotatable about a drum axis and positioned opposite the rotating roller star drum, the vacuum drum rotates at a speed higher than the speed of the rotating roller star drum and holds a label to be attached to each of the plurality of articles coming into the labeling zone; and
a servo mechanism controlled by a programmed control panel with a user machine interface, the servo mechanism controls the infeed acceleration of the active star wheel and the speed of each of the plurality of articles fed through the conveyor;
whereby the servo mechanism controls the infeed acceleration of the active star wheel and each of the plurality of articles goes past the active star wheel, then between at least two of the plurality of rollers of the rotating roller star drum and the vacuum drum, which spins each of the plurality of articles into the labeling zone by the speeding up of the rotating roller star drum and the slowing down of the vacuum drum for the application of the label thereto.

2. The servo controlled labeling apparatus of claim 1 wherein the active star wheel provides a continuous motion of the plurality of articles into the labeling zone.

3. The servo controlled labeling apparatus of claim 1 wherein the servomechanism and the active star wheel controls the infeed acceleration of the plurality of articles.

4. The servo controlled labeling apparatus of claim 1 wherein the rotating roller star drum operates at a different speed with respect to speed of the vacuum drum and imparts rotational motion to the plurality of articles.

5. The servo controlled labeling apparatus of claim 1 wherein the speed of the vacuum drum increases above the speed of the rotating roller star drum which imparts a rotational motion to the plurality of articles.

6. The servo controlled labeling apparatus of claim 1 wherein as each of the plurality of articles enters the labeling zone, the vacuum drum slows down and the rotating roller star drum speeds up.

7. The servo controlled labeling apparatus of claim 1 wherein as each of the plurality of articles enters the labeling zone, the rotating roller star slows down and the vacuum drum speeds up.

8. The servo controlled labeling apparatus of claim 1 wherein as each of the plurality of articles enters the labeling zone, the rotating roller star remains at a constant speed and the vacuum drum speeds up.

9. The servo controlled labeling apparatus of claim 1 wherein when each of the plurality of articles is pressed against the plurality of rollers of the rotating roller star drum and the vacuum drum, the plurality of rollers deforms slightly due to the pressure and the label is applied on to each of the plurality of articles.

10. A labeling apparatus, comprising:
a conveyor for supplying a plurality of articles into a labeling zone through a conveyor guide, the conveyor guide configured to constrain the plurality of articles passing there through;
an active star wheel having a plurality of arms to form a plurality of pockets, the active star wheel adaptable to rotate about a central axis;
a rotating roller star drum having a plurality of rollers, each of the plurality of rollers includes a plurality of flexible discs arranged in a stacked manner, the rotating roller star drum employed to guide each of the plurality of articles from the active star wheel to the labeling zone utilizing at least two of the plurality of rollers; and
a vacuum drum rotatable about a drum axis and positioned opposite the rotating roller star drum, the vacuum drum rotates at a speed higher than the speed of the rotating roller star drum; and
a servo mechanism controlled by a programmed control panel with a user machine interface, the servo mechanism controls the infeed acceleration of the active star wheel and the speed of each of the plurality of articles fed through the conveyor;
whereby the servo mechanism controls the infeed acceleration of the active star wheel which receives each of the plurality of articles through the conveyor and passes them between at least two of the plurality of rollers of the rotating roller star drum and the vacuum drum that spins each of the plurality of articles into the labeling zone by speeding up the rotating roller star drum and slowing down the vacuum drum for the application of a label thereto.

11. The labeling apparatus of claim 10 wherein each of the plurality of pockets of the active star wheel is adaptable to receive each of the plurality of articles through the conveyor.

12. The labeling apparatus of claim 10 wherein the vacuum drum holds a label to be attached to each of the plurality of articles coming into the labeling zone.

13. The labeling apparatus of claim 10 wherein the active star wheel provides a continuous motion of the plurality of articles into the labeling zone.

14. The labeling apparatus of claim 10 wherein the servo mechanism and the active star wheel controls the infeed acceleration of the plurality of articles.

15. The labeling apparatus of claim 10 wherein the rotating roller star drum operates at a different speed with respect to speed of the vacuum drum and imparts rotational motion to the plurality of articles.

16. The labeling apparatus of claim 10 wherein as each of the plurality of articles enters the labeling zone the vacuum drum slows down and the rotating roller star drum speeds up

17. The labeling apparatus of claim 10 wherein when each of the plurality of articles is pressed against the plurality of rollers of the rotating roller star drum and the vacuum drum, the plurality of rollers deforms slightly due to the pressure and the label is applied on to each of the plurality of articles.

18. A method for applying labels to a plurality of articles, the method comprising the steps of:
a) providing a labeling apparatus comprising a conveyor for supplying a plurality of articles into a labeling zone through a conveyor guide, an active star wheel having a plurality of arms to form a plurality of pockets, a rotating roller star drum having a plurality of rollers, each of the plurality of rollers includes a plurality of flexible discs arranged in a stacked manner and a vacuum drum rotatable about a drum axis and positioned opposite the rotating roller star drum;
b) moving a plurality of articles into the labeling zone through the conveyor by means of a servo mechanism;
c) receiving each of the plurality of articles in the pocket of the active star wheel;
d) passing each of the plurality of articles into at least two of the plurality of rollers of the rotating roller star drum;
e) rotating each of the plurality of articles between at least two of the plurality of rollers of the rotating roller star drum and the vacuum drum;
e) spinning each of the plurality of articles into the labeling zone by speeding up the rotating roller star drum and slowing down the vacuum drum by the servo mechanism for the application of a label thereto; and
f) applying the label positioned on the vacuum drum on each of the plurality of articles when each of the plurality of articles is pressed against the plurality of rollers of the rotating roller star drum and the vacuum drum.

19. The method of claim 18 wherein the active star wheel is adaptable to rotate about a central axis by means of the servomechanism.

20. The method of claim 18 wherein the vacuum drum rotates at a speed higher than the speed of the rotating roller star drum.
